(19) United States
(12) Patent Application Publication
(10) Pub. No.: US 2003/0023555 A1
(43) Pub. Date: Jan. 30, 2003

(54) Method and system for providing financial services

(75) Inventor: Kenneth E. Rees, Dallas, TX (US)

Correspondence Address: HAYNES AND BOONE, LLP, 901 MAIN STREET, SUITE 3100, DALLAS, TX, 75202, US

(73) Assignee: CashWorks, Inc., Dallas, TX

(21) Appl. No.: 10/200,690

(22) Filed: Jul. 22, 2002

Related U.S. Application Data
(60) Provisional application No. 60/307,655, filed on Jul. 26, 2001.

(51) Int. Cl. G06F 17/60

(52) U.S. Cl. 705/44

(57) ABSTRACT

A system and method for initiating and fulfilling customer-initiated, clerk-assisted, financial services such as check cashing, payday loans, money transfers, and bill payments. The system may include: an input device, a device for reading check MICR information, a storage device, an electronic processor with rules for approving or declining transactions, an Automated Teller Machine (ATM), and an ATM switch. Customers initiate the financial transactions using the input device or an ATM, clerks authenticate the customer and/or the transaction with the input device, the electronic processor approves or declines the transactions, and the transactions are fulfilled by a clerk or an ATM.

### CROSS-REFERENCE

This invention claims the benefit of and incorporates by reference the following U.S. provisional patent application: Serial No. 60/307,655 filed on Jul. 26, 2001.

### BACKGROUND OF THE INVENTION

This invention applies to the delivery of financial services such as check cashing, payday loans, bill pay, money transfer, and money orders. These products are used by approximately 25% of Americans who spend well over $3 billion annually on these services (Source: Dove Consulting, Survey of Non-Bank Financial Institutions for the Dept of the Treasury, Apr. 4, 2000). These consumers either don't have a bank account, or supplement their account with non-bank financial services because of a need for immediate cash.

There are three primary distribution channels for these services at present, manned check cashing stores, “courtesy counters” at grocery stores and other retailers, and check cashing machines.

The largest channel is manned check cashing stores. Manned check cashing stores are brick-and-mortar locations staffed by employees who process the financial transactions. They typically offer check cashing, money transfers, money orders, bill payment, phone cards, and where allowed by law, payday loans. Ace and Dollar Financial are the two largest manned check cashing chains with a total of approximately 2,500 stores combined (Source: Ace and Dollar published data). The primary disadvantage of the manned check-cashing store is its high fixed cost structure. They must pay rent and utility costs on the location as well as keep it staffed during both high and low volume hours of operation. Because of this, there are a very limited number of locations that can profitably support a manned check cashing stores. Furthermore, they are typically located in poor parts of town and in many cases are inconvenient and unsafe for consumers. Also, most locations are not open 24 hours a day because of the cost of staffing late-night employees. Additionally, most use bullet-proof glass between the customer and the check cashing employees to prevent theft, which creates an unpleasant customer experience and employee working environment.

The second channel is grocery stores and other retailers who offer the services to attract consumers to their store. Typically, retailers set up a “courtesy counter” staffed by store employees to provide services such as check cashing, money transfer, and bill payment. Low-paid employees perform the underwriting for these products with no or limited automation support. Hence, these locations face high loss rates and personnel costs related to performing the services. Furthermore, these locations must carry a great deal of cash on site to fulfill the transactions. Carrying high inventories of cash is an additional cost for the store as well as an attraction to theft (both internal and external), creating a dangerous situation for store employees and customers. Because of the above problems, most retailers don't offer these services and many of the chains that do are evaluating other alternatives.

Recently, a new distribution channel has been created using multi-function ATMs as automated check cashing machines (CCMs). U.S. Pat. Nos. 6,149,056 ('056), and 6,145,738 ('738) refer to an “automated check cashing machine” that was brought to market by Mr. Payroll (later named Inno V entry). Similar devices have been deployed by 7-Eleven, Greenland Corp., and Western Union. These machines are multi-function ATMs with additional hardware, which lets them accept checks and in some cases dispense money orders. They use biometrics or cards to identify the customer, and are typically linked to a central server and a call center. This allows the machines to automatically approve certain transactions that fall within acceptable risk parameters while sending unusual or particularly risky transactions to be reviewed by a human operator in the call center. In the patents '058 and '738, as well as in the case of currently deployed devices, the transaction is initiated and completed by the customer using the check-cashing machine.

Now turning to FIG. 1, the typical check cashing process for customers using an automated check-cashing machine is described. The customer first uses a CCM to initiate the transaction 100. The CCM sends transaction information to the central server in module 102. The central server then approves, declines or sends the transaction to the call center for operator review 104. If the transaction is approved, the customer uses CCM to accept the transaction 106, and then the CCM dispenses the cash and a receipt 108. If the transaction is declined, the CCM returns the customer check and prints out a receipt 110. On the other hand, if the transaction goes to operator review, the call center operator reviews the transaction 112 and the process then starts over at the central server decision point 104.

These machines as well as the check cashing process suffer from a number of disadvantages. One example is that check cashing machines are more expensive than traditional ATMs. While traditional ATMs typically cost less than $10,000, because of the additional hardware and processing requirements, check cashing machines typically cost $30,000 to $60,000.

Check cashing machines also break down more frequently than traditional ATMs. Because of the additional hardware and the difficulty of paper-handling in a self-service environment, there are often jams and other malfunctions. This results in higher monitoring and maintenance costs than a traditional ATM as well as customer service problems when checks get stuck in the machine.

Moreover, check cashing machines generate a tremendous amount of data for each transaction (due in particular to the check and biometric images). This approach requires expensive, high-bandwidth telecommunications lines, typically frame-relay, DSL, or ISDN, whereas traditional ATMs may only use a traditional dial-up line. Even with the high-bandwidth lines, it can take up to 30 seconds to transmit the transaction information from the check-cashing machine to the central server. Furthermore, this information must be stored to be used for future transactions which creates an extremely large (and expensive) database.

Additionally, check cashing machines face a significant disadvantage against manned environments because of the difficulty of authenticating the customer or the check without having a human view the customer I.D. or check personally. Typically, companies who deploy check-cashing machines must ask customers information from credit bureau data to authenticate the customer. However, this data is often out-of-date or unavailable if the customer doesn't have a credit history. Furthermore, some check fraud detection can only be performed by a physical inspection of the check (for instance, to look for “watermarks” and other identifiers which can't be detected by check readers). Hence, loss rates and customer declines are both higher with check cashing machines than manned environments.

Check cashing machines also have customer queuing problems in high customer volume locations. Because the customer must wait in front of the machine while the check is approved or declined, any delays at the call center to review the transaction also delay other customers waiting at the machine. This is frustrating for other customers in line as well as embarrassing for the customer waiting to be approved.

In addition, check cashing machines take up more space than a traditional ATM. Currently deployed check-cashing machines have a significantly larger footprint than traditional cash dispenser-type ATMs. Furthermore, since most retailers already have contracts for ATM services, most check cashing machines are installed in addition to a traditional ATM.

Check cashing machines require either biometrics or cards to identify customers. Biometrics have significant problems in the field and often either malfunction or mis-read the customer due to mechanical problems or lack of customer “participation.” Cards are also problematic since they add cost and must be carried at all times by customers who may lose them or may not want to carry them in their wallets or purses. Also, cards either must be dispensed through a card dispenser at the machine (which is expensive and can jam) or through the mail (which delays the first customer transaction).

### SUMMARY OF THE INVENTION

The invention is a new system and several processes for delivering financial transactions such as check cashing, payday loans, and money transfers. The system uses a point-of-sale terminal (referred to as a PayPort), a central server (referred to as the Central Decision Engine, or CDE), an ATM, and call center software (referred to as a Transaction Center Workstation, or TCW) to initiate and fulfill the financial services. The financial transactions are initiated by customers using a PayPort or an ATM, utilize clerks at the PayPort to authenticate the customer and/or the transaction, are approved or declined centrally by the Central Decision Engine, and are fulfilled at either a PayPort or an ATM.

Objects and advantages of the present invention over manned check cashing locations are as follows:

to provide a process and system that can be deployed in retailers without requiring a stand-alone brick-and-mortar location;

to provide a process and system that will have low fixed costs and can be deployed in even low-volume retailers cost-effectively;

to provide a process and system that can be cost-effectively operated 24 hours a day, 7 days a week; and

to provide a process and system that will not require bullet-proof glass or other security devices for store personnel and customers.

Objects and advantages of the present invention over “courtesy counters” at grocery stores and other retailers are as follows:

to provide a process and system with central decision-making and underwriting to remove responsibility and time-consuming manual verifications from store clerks;

to provide a process and system that will have low fixed costs and can be deployed in even low-volume retailers cost-effectively; and

to provide a process and system which does not require the retailer to stock additional cash (resulting in lower costs and improved security).

Objects and advantages of the present invention over check cashing machines are as follows:

to provide a process and system that does not require expensive new hardware and leverages existing ATMs;

to provide a process and system that is more reliable than check cashing machines and does not suffer from jams and malfunctions due to check paper handling;

to provide a process and system that requires significantly less data transmission and storage space than current check cashing machines, and does not require high-bandwidth telecommunications lines;

to provide a process and system which avoids the customer identity authentication and check verification problems of self-service solutions;

to provide a process and system which eliminates the queuing problems of current check cashing machines;

to provide a process and system which does not require additional floor space at the retailer location; and

to provide a process and system that does not require a card or biometrics for customer identification and can be used by the customer the first time they enroll in the system, without a delayed sign-up process.

Therefore, in accordance with the previous summary, objects, features and advantages of the present disclosure will become apparent to one skilled in the art from the subsequent description and the appended claims taken in conjunction with the accompanying drawings.

### BRIEF DESCRIPTION OF THE DRAWINGS

FIG. 1. describes a typical check cashing machine transaction flow;

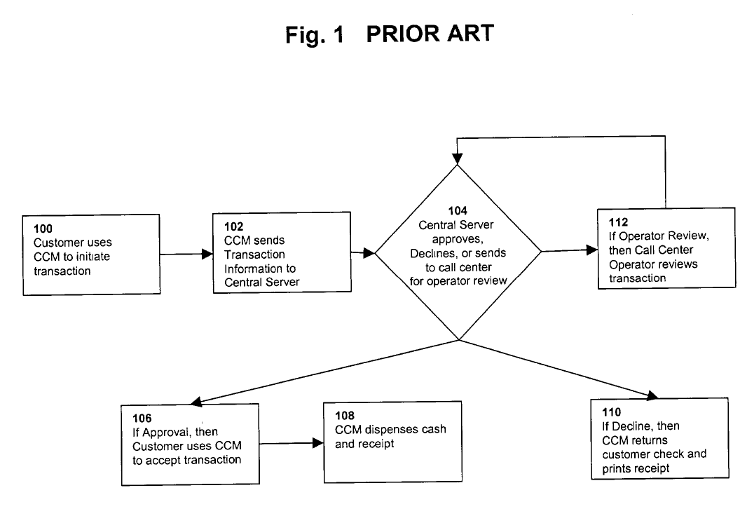

FIG. 2. describes the preferred embodiment of the system of the invention;

FIG. 3. describes an additional embodiment of the system of the invention with the ATM connected to a ATM Switch, which is in turn connected to the CDE;

FIG. 4. describes an additional embodiment of the system of the invention with no Transaction Center Workstation;

FIG. 5 describes an additional embodiment of the system of the invention with a cash dispensing device instead of an ATM;

FIG. 6 describes an additional embodiment of the system of the invention without an ATM;

FIG. 7. shows the check cashing process flow;

FIG. 8. shows the payday loan process flow; and

FIG. 9. shows the money transfer process flow.

### DETAILED DESCRIPTION OF THE PREFERRED EMBODIMENTS

The present disclosure can be described by the embodiments given below. It is understood, however, that the embodiments below are not necessarily limitations to the present disclosure, but are used to describe a typical implementation of the invention. A list of reference numerals in the drawings will first be described and then the details of the embodiment will be described.

Reference Numerals In Drawings

| | |
|---|---|
| 11 | PayPort |
| 12 | Central Decision Engine - CDE |
| 13 | ATM |
| 14 | Transaction Center Workstation - TCW |
| 15 | ATM Switch |
| 16 | ATM Networks |
| 17 | Cash Dispensing Device |

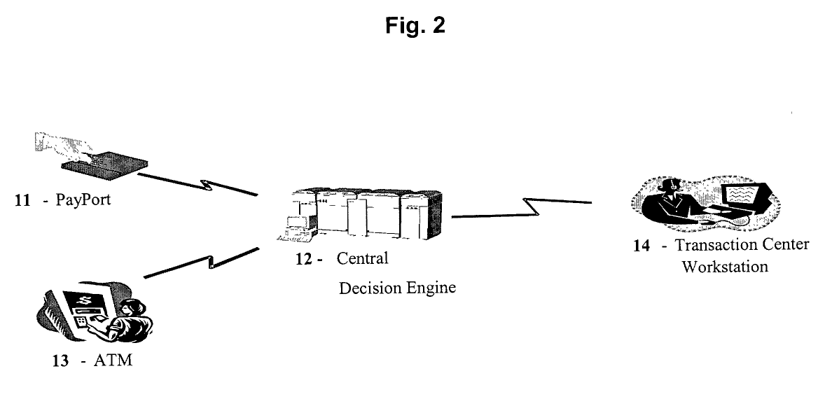

The preferred embodiment of the invention system is illustrated in FIG. 2. A PayPort 11 and an ATM 13 are connected to a Central Decision Engine (CDE) 12. The CDE is connected to a Transaction Center Workstation (TCW) 14.

The PayPort 11 is a point-of-sale data entry device with a PIN-pad or other keyboard, and a check Magnetic Ink Character Recognition (MICR) reader and/or check scanner. It also has an information display for the customer and/or the store clerk. This display could be a simple, one-line display or a larger full-screen display. Optionally, the PayPort may have a magnetic card reader and/or barcode reader attachment. The PayPort 11 can contain these functions in a single integrated unit or be linked to other peripherals or devices to perform these functions. The PayPort 11 is programmed to initiate and process financial services and is connected to the CDE 12 by a dial-up, frame-relay, ISDN, or DSL line in this embodiment.

The CDE 12 includes software located on a computer processor with data storage capability. It processes incoming transaction requests and data from the PayPort 11, the ATM 13, and the TCW 14. It is a flexible application for underwriting financial services. When it receives a message, it identifies the transaction type (e.g. check cashing, loan, etc.), parses each of the message fields (e.g. payor, payee, amount, date, etc) and uses pre-defined rules and internal and external databases to determine whether to approve or decline the transaction, or refer the transaction to a Transaction Center operator using the TCW 14. The CDE takes into consideration any combination of the location of PayPort, past customer and payor transaction history, and various other risk factors to make the decision. The appropriate message is then transmitted back to the initiating device.

The ATM 13 can be a simple cash dispenser or a multi-function ATM, but includes software that can initiate and fulfill financial services in addition to traditional ATM transactions. This software can be written in the legacy OS/2 environment (currently installed in most ATMs deployed today) as well as Windows NT or other operating environments. It may use a touch-screen interface (if available) or the ATM keypad and function keys. Financial services transactions may be sent via dial-up, frame-relay, ISDN, or DSL phone lines to the CDE 12.

In certain cases, the CDE 12 may refer a transaction to a TCW 14 used by an operator in a Transaction Center for additional analysis. This may be due to high dollar value or other potential fraud risks. The CDE 12 uses pre-defined rules and internal and external databases to determine when to send the transaction to a TCW 14 for operator review. The TCW 14 includes a computer with software that supports human underwriting processes and displays instructions as well as provides transaction-related data. Once the operator has completed the verifications, the TCW 14 returns this result to the CDE 12 which transmits the decision to the PayPort 11 and/or ATM 13. The TCW 14 may also track operator productivity and schedule adherence.

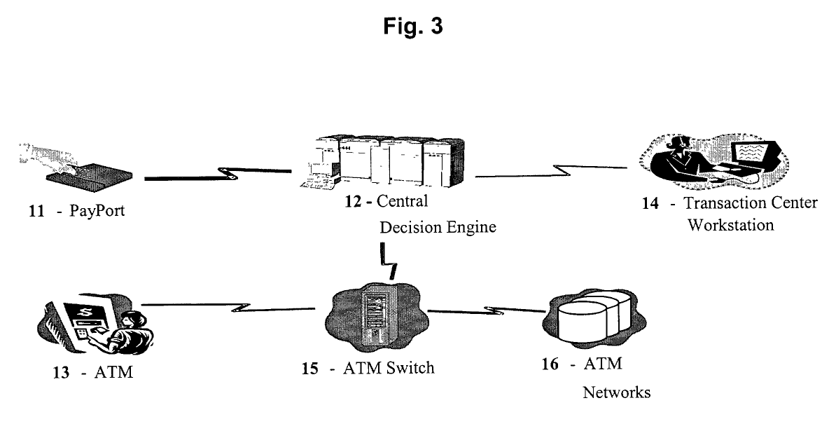

In FIG. 3., the ATM 11 is connected to the CDE 12 through the ATM Switch 15 rather than directly to the CDE 12. The ATM Switch 15 is software located on a computer processor. The ATM Switch 15 receives transactions from the ATM 13. The ATM Switch 15 has been modified to recognize certain financial transactions (e.g. check cashing, lending, etc.) and send them to the CDE 12 while still able to recognize standard ATM transactions and send them to the appropriate ATM Network 16 (e.g. Pulse, Star, etc.). Furthermore, the ATM Switch 15 receives responses from the CDE 12 and the ATM Networks 16 and routes them back to the ATM 13. Transaction information may be stored on the ATM Switch 15 and generate reports necessary for balancing and settlement with the retailer, ATM deployers, the ATM Networks 16, and other product providers. The ATM Switch 15 may be connected directly to the CDE 12 or may pass transactions to another ATM Switch 14 as an intermediary with the CDE 12.

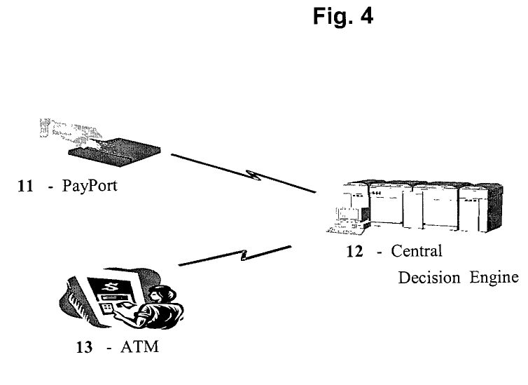

In FIG. 4., there is no TCW 15. This embodiment is for the situation where all decisions are made without the need for operator review, hence there is no need for the TCW 14.

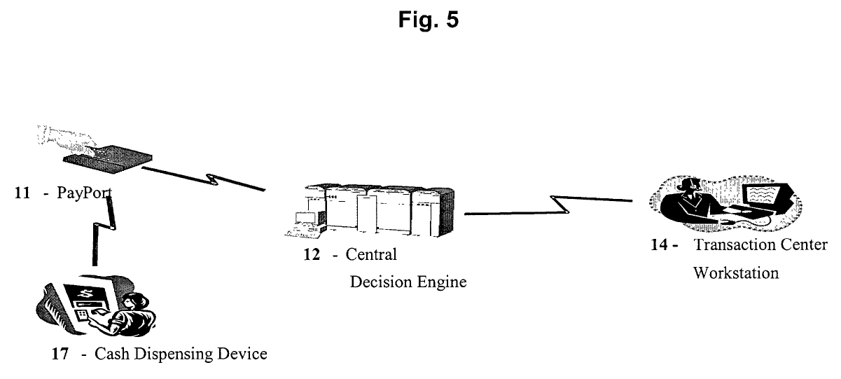

In FIG. 5., instead of an ATM, cash is dispensed with a dedicated Cash Dispensing Device 17 (e.g. a cash dispensing safe) that is not capable of standard ATM transactions. This embodiment is for situations where there is no need for standard ATM transactions in the location.

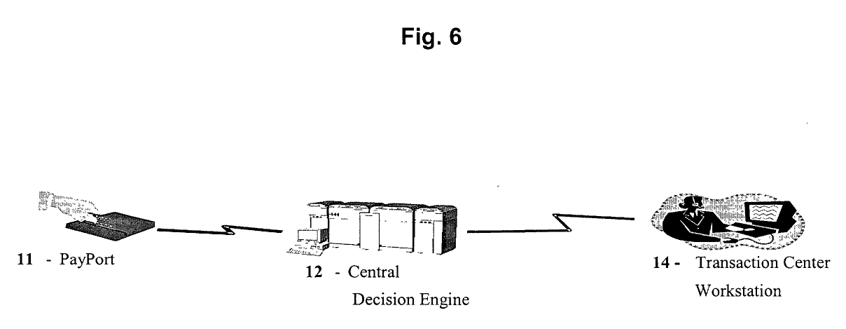

In FIG. 6., there is no ATM. This embodiment is for situations where the store dispenses the funds directly from the cash register.

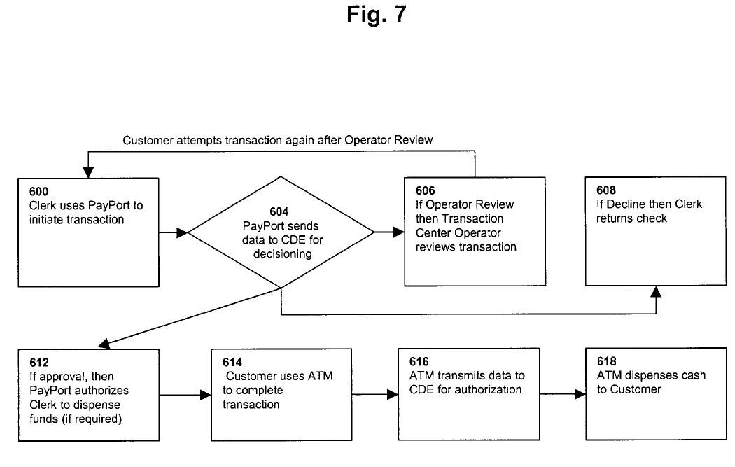

The preferred embodiment of the check cashing process flow is shown in FIG. 7. A check cashing transaction is used to provide immediate funds to a customer for a check made out to them instead of waiting until the check clears the banking system.

The Customer first gives the check and an ID (e.g. drivers license, employee ID, Mexican Matricula, etc.) to a Clerk 600. The Clerk performs a visual inspection of the check and verifies the check amount. The clerk swipes the check through the check MICR reader or check scanner and keys information about the check that is prompted by the PayPort (for instance, check amount, check type, date of issuance, and/or phone number of check payor). The Clerk also swipes the Customer's ID through the PayPort or enters the ID number.

The PayPort then sends the transaction information to the CDE for immediate decisioning 604. In this embodiment, the CDE uses pre-defined decision-rules and internal and external databases to evaluate the check information and historical information on the customer and check payor. Based on this analysis, the CDE returns to the PayPort an approval message, a decline message, or a message indicating that the transaction will be reviewed by an Operator in a Transaction Center.

If the CDE recommends that an Operator review the transaction 606, the PayPort indicates the decision of the CDE, and the Customer may return later to find out the Operator decision. In parallel, the PayPort sends the transaction to a TCW in the Transaction Center. An Operator in the Transaction Center uses the TCW to evaluate the risk of the check and may perform additional verifications (such as contacting the maker of the check or the bank on which the check was written). The Operator enters the verification information into the TCW, and the TCW returns the information to the CDE. When the Customer attempts to cash the check in the future, the CDE will either approve or decline the check based on the Operator-entered information.

If the Customer is declined by the CDE, the PayPort indicates the decision of the CDE, and the Clerk returns the check to the Customer 608.

If the Customer is approved by the CDE, the PayPort displays the amount (if any) that the Clerk must dispense to the Customer 612. Since most ATMs only stock $20s, the PayPort will typically display the remainder of the funds due to the Customer divided by $20 (for example, if the amount due was $255.43, then the PayPort would authorize the Clerk to dispense $15.43 to the Customer). Depending on the denominations stocked in the ATM, the calculation of the amount to be dispensed by the Clerk may vary. The Clerk then dispenses the amount displayed by the PayPort.

The Customer then uses an ATM to collect the balance of the amount due 614.

The ATM transmits the data to the CDE for decisioning 616. If the transaction has been approved by the CDE, the CDE will send an approval code and an amount to be dispensed to the ATM.

To complete the transaction, the ATM dispenses the amount of cash due to the Customer 618.

All check types including payroll, government, money orders, two-party personal, and one-party personal can be processed with this invention.

Another additional embodiment of this process is for a high volume location and uses two separate PayPorts. In this embodiment, a Customer uses PayPort A to initiate the transaction by selecting the “cash check” transaction and swiping the check through PayPort A's check MICR reader or check scanner. Next, the Customer swipes his ID or enters the ID number into PayPort A and keys information about the check prompted by PayPort A (for instance, check amount, check type, date of issuance, etc.). PayPort A sends this information to the CDE for decisioning. If approved, the CDE returns an authorization code to PayPort A informing the Customer that he has been approved. PayPort A then prompts the Customer to go to a Clerk. The Customer gives the check to the Clerk who swipes the check through PayPort B's check MICR reader or check scanner and keys information about the check prompted by PayPort B. PayPort B sends this information to the CDE and the transaction then continues the same process as the preferred embodiment.

An additional embodiment of this process is for the check cashing transaction to be “chained” to another transaction type where (for instance) some or all of the monetary proceeds of the check cashing transaction could be sent via money transfer to a third party.

An additional embodiment of this process is for the customer to use an identification card made for this system or some type of biometrics instead of an ID. In this example, the identification card could be given to the customer the first time the customer uses the system and then can be re-used from then on.

An additional embodiment of this process is for the monetary proceeds of the check cashing transaction to be loaded on a pre-paid debit/credit card. In this example, the system would contact the financial institution related to the debit/credit card to authorize the monies to be dispensed from the ATM. The customer then uses the debit/credit card at the ATM and receives the cash due to the customer.

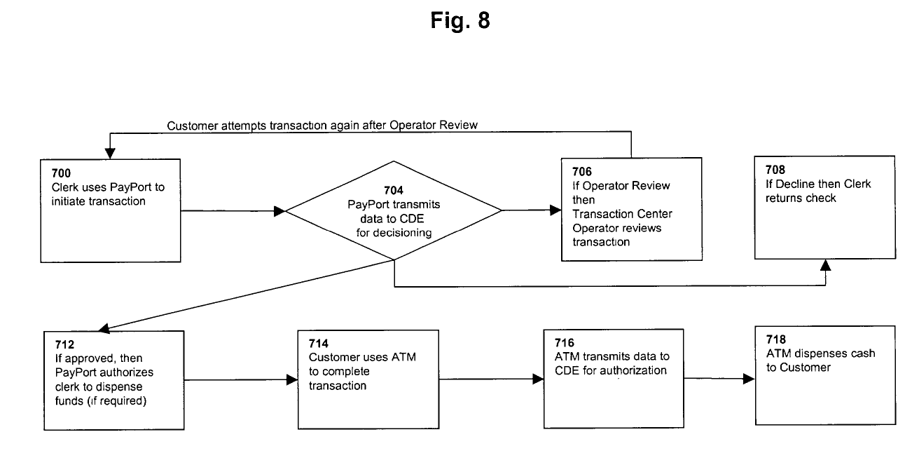

The preferred embodiment of the payday loan process flow is shown in FIG. 8. A payday loan transaction is used to provide a short-term loan to a customer in advance of their next payroll check. The Customer must have a bank checking account to use the service in this embodiment. The customer “secures” the loan by presenting a check from his checking account for the amount of the loan and fee. If approved, the customer receives the amount of the loan. On the date of the next payday (or other agreed upon date), the lender collects the loan principal and fee by depositing the check (e.g. physically or via ACH).

A Clerk uses the PayPort to initiate the transaction by selecting the “payday loan” transaction 700. The Customer gives the Clerk a check from the Customer's bank account who swipes it in the PayPort's check MICR reader or check scanner. The Clerk enters the amount of the requested loan and any additional information required by the PayPort.

The PayPort sends the transaction information to the CDE for immediate decisioning 704. In this embodiment, the CDE uses pre-defined decision-rules to evaluate the check information along with historical information on the Customer and may use data gathered from external sources. Based on this analysis, the CDE returns to the PayPort an approval code, a decline code, or a code indicating that the transaction will be reviewed later by an Operator in the Transaction Center. In the case of an approval, the CDE also returns the amount of loan that is being approved (it may be less than requested by the Customer) and the fee amount for the transaction.

If the CDE recommends that an Operator review the transaction 706, the PayPort indicates the decision of the CDE, and the Customer may return later to find out the Operator decision. In parallel, the CDE sends the transaction to a TCW in the Transaction Center. An Operator in the Transaction Center uses the TCW to evaluate the credit-worthiness of the Customer and may perform additional verifications. Based on the Operator analysis, he returns an approval or decline code to the CDE. Additionally, when the Customer attempts to get a loan in the future, the CDE may either approve or decline the loan based on the Operator decision.

If the Customer is declined by the CDE 708, the PayPort indicates the decision of the CDE.

If the Customer is approved by the CDE, the PayPort indicates the decision of the CDE and displays the amount (if any) that the Clerk must dispense to the Customer 712. In most cases, since loan amounts are typically a multiple of $100, the Clerk will not be asked to dispense funds for a payday loan. However, if the loan was for an odd amount, say $255.43, since most ATMs only stock $20s, the PayPort will typically display the remainder of the funds due to the Customer divided by $20 (for example, if the loan amount was $255.43, then the PayPort would authorize the Clerk to dispense $15.43 to the Customer). Depending on the denominations stocked in the ATM, the calculation of the amount to be dispensed by the Clerk may vary. The Clerk then dispenses the amount displayed by the PayPort. The PayPort prints an Authorization Code on the receipt for the Customer. If the check will be deposited physically, then the Clerk retains the Customer's check. However, if the check will be deposited electronically via ACH, the Clerk returns the check to the Customer or destroys it.

The Customer then uses an ATM to collect the balance of the loan amount due 714.

The ATM transmits the data to the CDE for decisioning 716. If the transaction has been approved by the CDE, the CDE will send an approval code and an amount to be dispensed to the ATM.

To complete the transaction, the ATM dispenses the amount of cash due to the Customer 718.

Another additional embodiment of this process is for high volume locations and uses two separate PayPorts. In this embodiment, a Customer uses PayPort A to initiate the transaction by selecting the “payday loan” transaction. Next, the Customer swipes his personal check through the check MICR reader and keys information about the loan prompted by the PayPort (for instance, loan amount). The PayPort A sends this information to the CDE for decisioning. If approved, the CDE returns an authorization code to PayPort A informing the Customer that he has been approved. PayPort A then prompts the Customer to go to a Clerk to complete the transaction. The Customer gives the check to the Clerk who swipes the check through PayPort B's check MICR reader or check scanner and enters any information required by the PayPort. PayPort B sends this information to the CDE and the transaction then continues the same process as the previous embodiment.

An additional embodiment of this process is for the check cashing transaction to be “chained” to another transaction type where (for instance) some or all of the monetary proceeds of the check cashing transaction could be sent via money transfer to a third party.

An additional embodiment of this process is for the customer to use an identification card made for this system or some type of biometrics instead of an ID. In this example, the identification card could be given to the customer the first time the customer uses the system and then can be re-used from then on.

An additional embodiment of this process is for the monetary proceeds of the check cashing transaction to be loaded on a pre-paid debit/credit card. In this example, the system would contact the financial institution related to the debit/credit card to authorize the monies to be dispensed from the ATM. The customer then uses the debit/credit card at the ATM and receives the cash due to the customer.

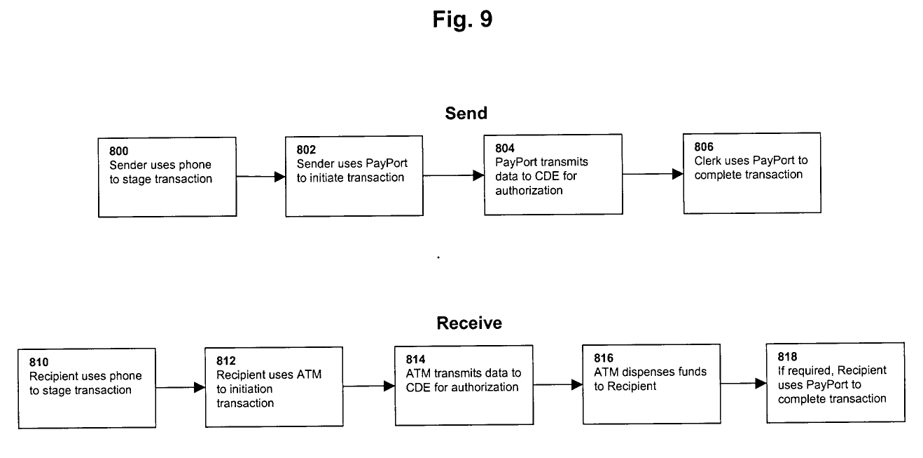

The preferred embodiment of the money transfer process flow is shown in FIG. 9. Money transfers are used by customers who need to quickly send money from one location to another. This is really a two-part process. In the “Send” part of the process, Customer A (the Sender) gives money to an intermediary to be sent to Customer B (the Recipient). In the “Receive” part of the process, Customer B (the Recipient) goes to an intermediary to receive the money sent by Customer A (the Sender). Western Union and Travelers Express/MoneyGram are the two most well-known money transfer providers. They typically use grocery stores and other retailers to collect and dispense the funds to be transferred. It should be noted that customers can send money to and from any site serviced by a money transfer provider, not just to and from sites using this invention.

A Sender first uses a phone to stage the money transfer transaction 800; the Sender calls a transaction processing center to provide information on where the money is to be sent. An Operator asks how much money the Sender wants to send, the identity of the recipient, and answers any additional questions that may be required by the money transfer product provider (e.g. security questions, recipient phone number). The Operator collects and enters all transaction information into a TCW, informs the Sender of the transaction fee, and tells the Sender to complete the transaction with a Clerk. The TCW transmits the transaction information to a CDE.

The Sender then uses a PayPort to initiate the transaction by selecting the “money transfer (send)” transaction 802, and being prompted to enter an ID number (either SSN, Drivers License or an ID number issued by the money transfer provider).

The transaction information is then sent by the PayPort to the CDE for immediate decisioning 804. If the transaction has been properly staged, the CDE will send back an approval code and the amount of the Sender fee and the total amount to be collected by the Clerk (i.e. amount to be sent and transaction fee). If the transaction has not been properly staged, the CDE will send back a decline code.

If approved, the Clerk will collect the amount listed on the PayPort from the Sender and use the PayPort to send an authorization code to the CDE for settlement with the money transfer provider 806.

Now turning to the “receive” part of the process, a Recipient uses a phone to stage the money transfer transaction 810. The Recipient calls a transaction processing center to provide information on receiving funds. An Operator asks how much money the Recipient expects to receive, the identity of the Sender, and answers any additional questions that may be required by the money transfer product provider (e.g. security questions). The Operator collects and enters all transaction information into a TCW, and tells the Recipient to complete the transaction at an ATM. The TCW transmits the transaction information to a CDE.

The Recipient goes to the ATM and selects the “Money Transfer (Receive)” transaction to initiate the transaction 812. The Recipient is prompted to enter an ID number (either SSN, drivers license, or ID number issued by the money transfer provider).

The ATM sends this information to the CDE to be approved or declined 814. If the transaction has been correctly staged, the CDE sends an approval code back to the ATM.

The ATM dispenses the funds to the Recipient to complete the money transfer transaction 816.

In the unlikely case that the amount to be dispensed cannot be completely dispensed by the ATM (e.g. the amount was not a multiple of $20), the ATM will direct the Recipient to a PayPort to receive the remaining funds 818. In this case, the Recipient uses the PayPort to complete the money transfer (receive) transaction by selecting the “money transfer (receive)” transaction, and being prompted to enter ID number (either SSN, drivers license, or the ID number issued by the money transfer provider). This information is sent by the PayPort to the CDE for immediate decisioning. If the funds were not completely dispensed by the ATM, the CDE will send an approval code and amount to be dispensed back to the PayPort. The Clerk will dispense the remaining funds to the Recipient and use the PayPort to authorize the successful completion of the money transfer (receive) transaction. The PayPort will send the authorization code to the CDE for settlement with the money transfer provider.

Thus, the system and methods of this invention provide significant advantages over the prior art:

The invention can be deployed in any retailer with an ATM that has the proper software;

The only additional fixed cost for using the invention is the cost of the PayPort;

Because any clerk can be quickly trained to use the PayPort, the process can be cost-effectively operated during retail store hours;

There is no need for bullet-proof glass or other security devices for store personnel and customers since the only significant additional cash inventories to process the transactions are securely stored in the ATM;

There is central decision-making and underwriting, which removes responsibility from regular store clerks;

There is no need for a special-purpose ATM or any additional hardware to be installed on the ATM;

Because the CDE will typically provide an immediate decision, most transactions will be processed faster than at manned locations;

Because this invention does not use a self-service check scanner, it does not suffer from paper jams or other malfunctions due to check paper handling;

The process does not require the transmission or storage of check images or biometrics, dramatically reducing telecommunications requirements, transmission times, and storage space requirements;

Because the clerk is able to verify checks and customer identification, fraud can be easily mitigated;

Customer queuing problems are lower than check cashing machines since customers are prompted to come back later in the case of operator review rather than standing at the machine, waiting for the final approval or decline;

There is no requirement for additional floor space; and

There is no requirement for cards or biometrics for customer identification (although these can be integrated into the invention if required).

While the above description contains many specificities, these should not be construed as limitations on the scope of the invention, but rather as an exemplification of the embodiments thereof. Many other variations are possible. For example, the invention can use identification cards or biometrics, or the order of data entry by the customer or clerk could vary. Also, the customer or clerk could do more data entry than detailed above. Many other variations to the system exist that ordinary skilled person in the art would envision to be within the spirit and scope of the claims. Consequently, it is understood that several modifications, changes and substitutions are intended in the foregoing disclosure and in some instances some features of the invention will be employed without a corresponding use of other features. Accordingly, it is appropriate that the appended claims be construed broadly and in a manner consistent with the scope of the invention.

1. A system for initiating and fulfilling financial services, comprising:
an input device configured to generate input signals in response to inputs from an operator to initiate a financial transaction;
a device for reading check Magnetic Ink Character Recognition (MICR) information connected to the input device;
an electronic processor connected to the input device and the check MICR reader;
a storage device including a database of customer information connected to the electronic processor;
an automated teller machine (ATM);
an ATM processor connected to the ATM and the electronic processor with software that supports financial transactions,
wherein the ATM is configured to:
send a customer-initiated financial transaction to the ATM processor,
receive transaction authorization messages from the ATM processor, and
dispense cash based on the authorization messages from the ATM processor,
wherein the ATM processor is configured to
receive a financial transaction from the ATM,
send the financial transaction from the ATM to the electronic processor,
receive authorization messages from the electronic processor, and
send the authorization message from the electronic processor to the ATM, and
wherein the electronic processor is configured to:
receive the input signals from the input device and the check MICR reader, the input signals identifying the transaction type, the customer identity, the amount of the transaction, the check MICR number, and other information required to initiate the transaction, and
determine whether to approve/decline the transaction sent from the input device and check MICR reader based on predefined transaction processing rules, and
send approval/decline codes to the input device to display to operator.

2. The system of claim 1 wherein the electronic processor is also configured to:
determine automatically whether to approve/decline the transaction sent from the ATM processor based on the transaction information, customer data, and predefined transaction processing rules stored at the electronic processor, and
send authorization codes to the ATM processor.

3. The system of claim 1 wherein the ATM processor is an ATM switch.

4. The system of claim 1 wherein the electronics processor and the ATM processor are the same processor.

5. The system of claim 1 wherein said input device also takes inputs from a biometric reader.

6. The system of claim 1 wherein said ATM processor is configured to also receive non-bank financial transaction requests from the input device and to send authorization codes to the input device.

7. The system of claim 1 further including a transaction center connected to the electronic processor that assists in determining whether to approve/decline the transaction.

8. A method for performing check cashing transactions comprising the steps of:
receiving customer identification information on a local apparatus;
passing the check to be cashed through a check MICR reader and keying such information as required to identify check to produce check detail;
sending the customer identification and check detail to a processor;
approving/declining the transaction based on pre-determined rules;
sending an approval/decline code to the local apparatus to display to an operator;
retaining the check if the transaction is approved;
keying in customer identification into an automated teller machine (ATM);
sending a transaction request to the processor from the ATM;
determining whether the transaction has been approved and an amount of cash to be dispensed;
sending an authorization code and amount to be dispensed to the ATM from the processor; and
dispensing the cash to the customer at the ATM.

9. The method of claim 8 wherein the check to be cashed is passed through a check MICR reader and such information as required to identify check is keyed before said local apparatus receives customer identification information.

10. The method of claim 8 wherein determining whether the transaction has been approved includes a decision by a transaction center operator.

11. The method of claim 8 wherein the processor also issues a unique transaction code to the customer which is entered by the customer into the ATM to identify the transaction.

12. A method for performing check cashing transactions comprising the steps of:
receiving customer identification information on a local apparatus;
passing the check to be cashed through a check MICR reader and keying such information as required to identify check to produce check detail;
sending the customer identification and check detail to a processor;
approving/declining the transaction based on pre-determined rules;
sending an approval/decline code to the local apparatus to display to an operator;
retaining the check if the transaction is approved and an amount of cash to be dispensed to the customer;
authorizing a financial institution to credit a specific debit/credit card for the amount of cash to be dispensed;
utilizing the debit/credit card with an automated teller machine (ATM);
sending a transaction request to the processor from the ATM;
determining whether the transaction has been approved and the amount of cash to be dispensed;
sending an authorization code and the amount to be dispensed to the ATM from the processor; and
dispensing the cash to the customer at the ATM.

13. The method of claim 12 further including issuing the debit/credit card to the customer on the first check cashing transaction that the customer initiates.

14. The method of claim 13 further including reusing the debit/credit card on subsequent check cashing transactions.

15. The method of claim 12 wherein the check to be cashed is passed through a check MICR reader and such information as required to identify check is keyed before said local apparatus receives customer identification information.

16. The method of claim 12 wherein determining whether the transaction has been approved includes a decision by a transaction center operator.

17. The method of claim 12 wherein the processor also issues a unique transaction code to the customer which is entered by the customer into the ATM to identify the transaction.
